(19) United States
(12) Patent Application Publication
(10) Pub. No.: US 2009/0242041 A1
(43) Pub. Date: Oct. 1, 2009

(54) Pressure control valve

(75) Inventors: Ryo Matsuda, Tokyo (JP); Hiroshi Yokota, Tokyo (JP); Daisuke Watari, Tokyo (JP); Shu Yanagisawa, Tokyo (JP)

Correspondence Address: BACON & THOMAS, PLLC, 625 SLATERS LANE, FOURTH FLOOR, ALEXANDRIA, VA, 22314-1176, US

(73) Assignee: Fujikoki Corporation, Tokyo (JP)

(21) Appl. No.: 12/382,777

(22) Filed: Mar. 24, 2009

(30) Foreign Application Priority Data
Mar. 26, 2008 (JP) 2008-080003

(51) Int. Cl. F16K 17/00; F16K 25/00

(52) U.S. Cl. 137/469; 251/85

(57) ABSTRACT

For downsizing, cost reduction, and better characteristic, a pressure control valve (1) consists of a valve main body (2) having a valve chamber (2a); a valve seat (2d) within the valve chamber; a valve body (3) moving close to and away from the valve seat; and a disc spring (11) for energizing the valve body toward the valve seat, the valve body moves away from the valve seat when force acting in a direction for moving the valve body away from the valve seat by pressure within the valve chamber exceeds elastic force of the disc spring, a dimension of the valve main body in a valve body movement direction is lessened by use of the disc spring, a manufacturing cost is reduced by use of the disc spring made for general purpose, and the disc spring is preferable for high-pressure control due to its high spring rigidity.

### BACKGROUND OF THE INVENTION

1. Field of the Invention

The present invention relates to a pressure control valve, and more particularly to a pressure control valve used in a refrigeration cycle or the like used in refrigeration and air conditioning relations.

2. Description of the Conventional Art

Conventionally, in the refrigeration cycle or the like, a pressure control valve is used for controlling pressure of a refrigerant. For example, a vapor compression type refrigeration cycle circulating a refrigerant in a closed circuit constructed by a compressor, a radiator, a pressure control valve (an expansion valve), an evaporator and the like is used in an air conditioning apparatus for a vehicle.

As one example of the pressure control valve used in the vapor compression type refrigeration cycle, Japanese Unexamined Patent Publication No. 2007-139209 describes a pressure control valve which is provided with a body having a refrigerant flow path extending from an internal heat exchanger to an evaporator via a valve port, a valve seat set within the refrigerant flow path, a valve body provided within the body to move close to and away from the valve seat, a diaphragm fixed to one end of the valve body, a lid body and a lower support portion forming a sealed space above the diaphragm, a spring attaching portion set in the other end of the valve body, a spring interposed between the spring attaching portion and the valve seat, and the like.

In the pressure control valve having the structure mentioned above, valve closing force of the valve body is obtained by internal pressure within the sealed space formed above the diaphragm fixed to one end of the valve body, and the spring interposed between the valve seat and the spring attaching portion of the valve body, and valve opening force of the valve body is obtained by pressure of the refrigerant from the internal heat exchanger. Further, valve close and valve open states are switched by balance between the valve closing force and the valve opening force.

### SUMMARY OF THE INVENTION

### Problem to be Solved by the Invention

However, in the pressure control valve described in the Japanese Unexamined Patent Publication No. 2007-139209, since the valve closing force with respect to the valve body is obtained by two factors of the internal pressure within the sealed space and the spring interposed between the valve seat and the spring attaching portion of the valve body, a space for the sealed space and for attaching the spring is necessary above and below the valve body, and thus there is a problem that a manufacturing cost rises as well as the valve is enlarged in size.

Further, there exists a pressure control valve in which valve closing force with respect to a valve body is obtained only by a coil spring for energizing the valve body in a direction toward a valve seat, however, a space for attaching the coil spring is necessary in the pressure control valve mentioned above, and there is a problem that it is unavoidable to enlarge the valve in size.

Accordingly, the present invention is made by taking the problem in the prior art mentioned above into consideration, and an object of the present invention is to provide a pressure control valve in which a valve main body can be downsized, a manufacturing cost is low, and a pressure control characteristic or the like can be easily regulated.

### Means for Solving the Problem

In order to achieve the object mentioned above, the present invention is a pressure control valve comprising:

a valve main body having a valve chamber in an internal portion;

a valve seat provided within the valve chamber;

a valve body moving close to and away from the valve seat; and

a disc spring for energizing the valve body in a direction toward the valve seat,

wherein the valve body moves away from the valve seat in the case that force acting in a direction for moving the valve body away from the valve seat on the basis of pressure within the valve chamber exceeds elastic force of the disc spring.

Thus, in accordance with the present invention, since the disc spring is used for energizing the valve body in the direction toward the valve seat, it is possible to lessen a dimension of the valve main body in a direction of the valve body movement, and it is possible to downsize the valve main body. Further, since the disc spring which is a general purpose part can be used, it is possible to reduce the manufacturing cost of the valve. Further, since the disc spring has a high spring rigidity, the disc spring can be preferably used in the vapor compression type refrigeration cycle or the like circulating a high-pressure refrigerant.

In the pressure control valve, a plurality of the disc springs can be placed.

Further, in the pressure control valve, a plurality of the disc springs can be placed in parallel. Accordingly, it is possible to provide a pressure regulating valve having high working pressure while a stroke of the valve body is made small.

Further, in the pressure control valve, a plurality of the disc springs can be layered in series. Accordingly, it is possible to provide a pressure regulating valve having a large stroke while working pressure is kept approximately constant.

### Effect of the Invention

As mentioned above, in accordance with the present invention, it is possible to provide the pressure control valve in which the valve main body can be downsized, the manufacturing cost is low, and the pressure control characteristic or the like can be easily regulated.

### BRIEF EXPLANATION OF DRAWINGS

FIG. 1 is a sectional view showing a first embodiment of a pressure control valve in accordance with the present invention, and shows a close state;

FIG. 2 is a sectional view showing an open state of the pressure control valve in FIG. 1;

FIG. 3 is a sectional view showing a second embodiment of the pressure control valve in accordance with the present invention, and shows a close state;

FIG. 4 is a sectional view showing a third embodiment of the pressure control valve in accordance with the present invention, and shows a close state; and

FIG. 5 is a sectional view showing a fourth embodiment of the pressure control valve in accordance with the present invention, and shows a close state.

### DETAILED DESCRIPTION OF PREFERRED EMBODIMENT

Next, a description will be given of embodiments in accordance with the present invention with reference to the accompanying drawings.

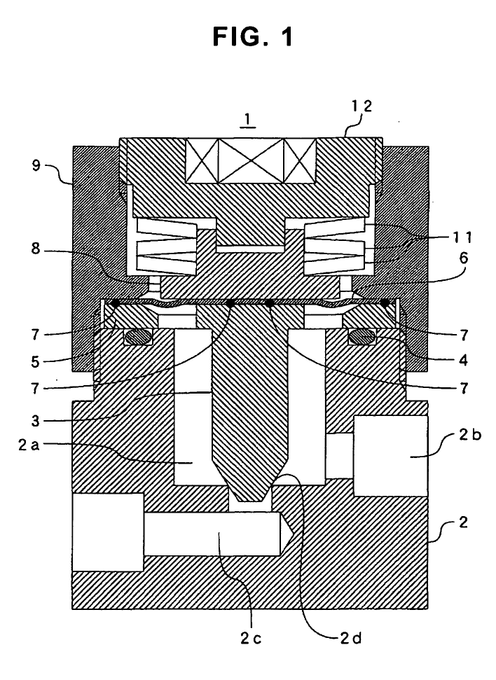

FIG. 1 shows a first embodiment of a pressure control valve in accordance with the present invention. The pressure control valve 1 is, broadly speaking, constructed by a valve main body 2 having a valve chamber 2a in an internal portion, a valve body 3 moving close to and away from a valve seat 2d within the valve chamber 2a, an annular receiving member 5 mounted on a top surface of the valve main body 2 via an O-ring 4, a diaphragm 6 supported by the receiving member 5 at its lower surface and interposed between the valve body 3 and a pressing member 8, a plurality of (three) disc springs 11 arranged above the pressing member 8 for energizing the pressing member 8 downward, a regulating screw 12 for regulating elastic force of the disc springs 11 to the pressing member 8, and the like. The diaphragm 6 is fixed by the valve body 3 and the receiving member 5 via a fixing means 7 such as welding or the like.

The valve main body 2 is screwed with a lid body 9 at its top portion, and the lid body 9 hold the diaphragm 6 between itself and the annular receiving member 5. A valve seat 2d being able to communicate with a flow path 2c is formed at a bottom portion of the valve chamber 2a. A conical lower end portion of the valve body 3 moves close to and away from the valve seat 2d, and thereby an opening of the valve seat 2d is closed and opened.

The diaphragm 6 is formed by an elastic body made of a metal or the like, and is structured such that, when fluid pressure in the valve chamber 2a rises, the diaphragm is elastically deformed and the valve body 3 is movable upward.

The pressing member 8 in contact with the diaphragm 6, the disc springs 11 and the regulating screw 12 are accommodated within the lid body 9. The pressing member 8 contacts with the diaphragm 6 at its lower surface, and the disc springs 11 are installed to a protruding portion at an upper portion thereof.

Three disc springs 11 are layered in series at the upper portion of the pressing member 8. The disc spring 11 at the highest position into contacts with the regulating screw 12, and energizing force of the disc springs 11 is transmitted to the diaphragm 6 via the pressing member 8.

The regulating screw 12 is provided for regulating the energizing force of the disc springs 11, and is engaged with the top portion of the lid body 9. It is possible to regulate the energizing force of the disc springs 11 by relatively moving the regulating screw with respect to the lid body 9.

Next, a description will be given of action of the pressure control valve 1 having the structure mentioned above with reference to FIG. 1.

FIG. 1 shows a state in which the pressure control valve 1 is closed. Since the valve body 3 contacts with the valve seat 2d in this state, fluid does not flow from the flow path 2b to the flow path 2c.

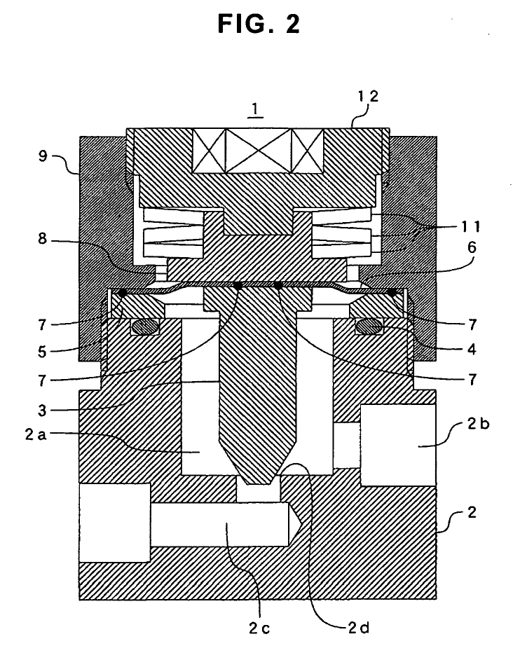

When fluid pressure within the valve chamber 2a rises, and upward pressing force F1 calculated by a product of the fluid pressure within the valve chamber 2a and an area of the diaphragm 6 becomes larger than elastic force (force pressing the diaphragm 6 downward via the pressing member 8) of the disc springs 11, the valve body 3 moves upward and a lower end portion of the valve body 3 is away from the valve seat 2d, as shown in FIG. 2. Accordingly, the fluid flows from the flow path 2b to the flow path 2c via the valve chamber 2a, and the pressure control valve 1 comes to an open state.

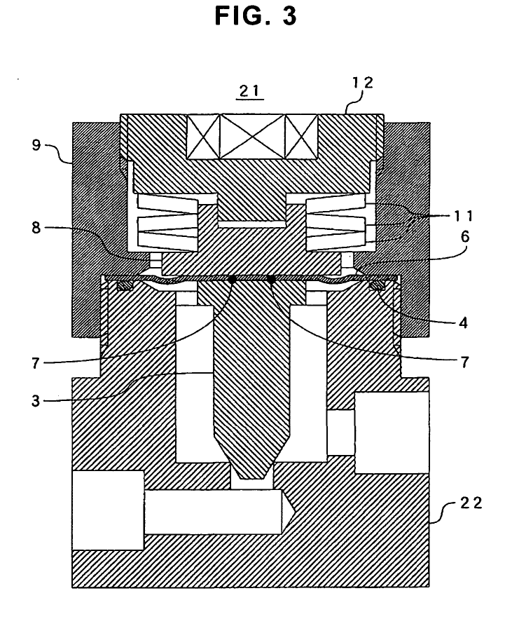

Next, a description will be given of a second embodiment of the pressure control valve in accordance with the present invention with reference to FIG. 3.

A pressure control valve 21 is structured such as to have a valve main body 22 obtained by integrally forming the valve main body 2 and the receiving member 5 of the pressure control valve 1 shown in FIG. 1. In accordance with this structure, since it is not necessary to fix the diaphragm 6 to the valve main body 22 in accordance with welding or the like, it is possible to reduce the number of pats of the pressure control valve and man hours required for manufacturing the pressure control valve. In this case, since the action of the pressure control valve 21 is the same as that of the pressure control valve 1, a description thereof will be omitted.

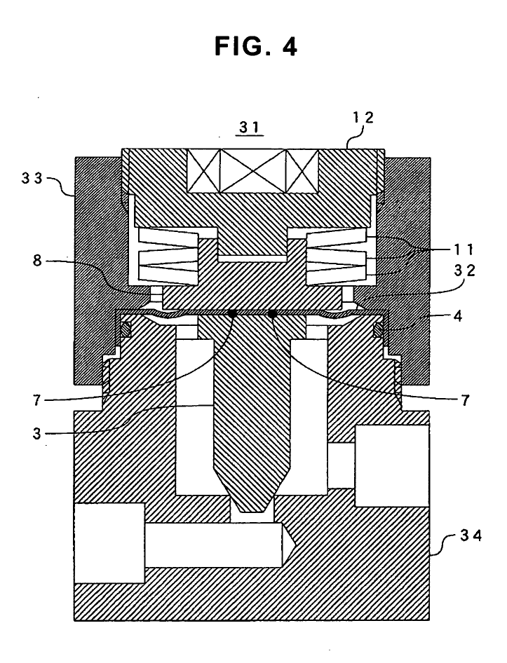

Next, a description will be given of a third embodiment of the pressure control valve in accordance with the present invention with reference to FIG. 4.

A pressure control valve 31 is provided with a diaphragm 32 formed in a closed-end cylindrical shape, and a lid body 33 and a valve main body 34 holding the diaphragm 32 therebetween in place of the diaphragm 6, the lid body 9 and the valve main body 22 of the pressure control valve 21 shown in FIG. 3, and the O-ring 4 is arranged at a side surface of the valve main body 34. Accordingly, since it is not necessary to fix the diaphragm 32 to the valve main body 34 by welding or the like similarly to the pressure control valve 21 in FIG. 3, it is possible to reduce the number of parts and man hours. Further, since the diaphragm 32 is formed in the closed-end cylindrical shape, it is possible to improve airtightness. In this case, since the action of the pressure control valve 31 is the same as that of the pressure control valve 1 mentioned above, a description thereof will be omitted.

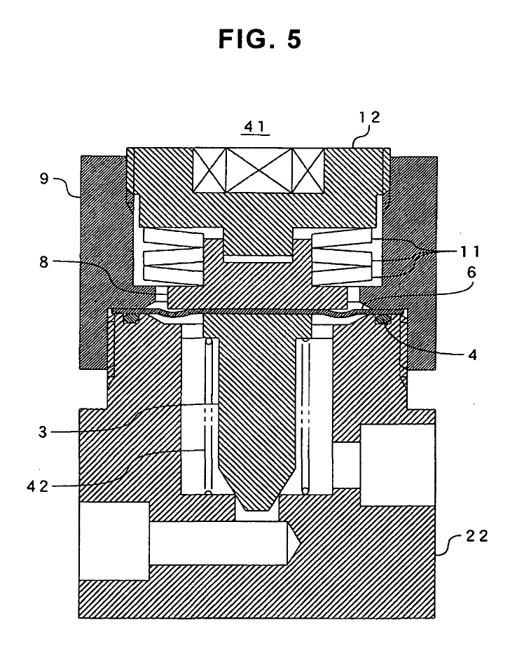

Next, a description will be given of a fourth embodiment of the pressure control valve in accordance with the present invention with reference to FIG. 5.

A pressure control valve 41 is provided with a coil spring 42 for energizing the valve body 3 toward the diaphragm 6 side, in addition to the structure of the pressure control valve 21 shown in FIG. 3. Accordingly, it is not necessary to fix the valve body 3 and the diaphragm 6 by welding or the like, and it is not necessary to fix the diaphragm 6 and the valve main body 22 by welding or the like, so that any equipment for welding or the like is not necessary for manufacturing the pressure control valve. In this case, since the action of the pressure control valve 41 is the same as the pressure control valve 1, a description thereof will be omitted.

In this case, in the embodiment mentioned above, three disc springs 11 are layered, however, the layering number of the disc springs 11 can be appropriately changed in correspondence to a desired valve body stroke and working pressure. Further, as for a direction of placing the disc springs 11, they may be layered in series such as an example shown in FIG. 1, and may be placed in parallel. It is possible to enlarge the stroke of the valve body 3 while the working pressure is kept approximately constant, by layering the disc springs 11 in series. Further, in the case that the disc springs 11 are placed in parallel, it is possible to increase the working pressure while the stroke of the valve body 3 is made small.

What is claimed is:

1. A pressure control valve comprising:
a valve main body having a valve chamber in an internal portion;
a valve seat provided within said valve chamber;
a valve body moving close to and away from said valve seat; and
a disc spring for energizing said valve body in a direction toward said valve seat,
wherein said valve body moves away from said valve seat in the case that force acting in a direction for moving said valve body away from said valve seat on the basis of pressure within said valve chamber exceeds elastic force of said disc spring.

2. A pressure control valve as claimed in claim 1, wherein a plurality of said disc springs are placed.

3. A pressure control valve as claimed in claim 2, wherein a plurality of said disc springs are placed in parallel.

4. A pressure control valve as claimed in claim 2, wherein a plurality of said disc springs are layered in series.
